(19) United States
(12) Patent Application Publication
(10) Pub. No.: US 2010/0039793 A1
(43) Pub. Date: Feb. 18, 2010

(54) Multi-directional standby lighting device

(76) Inventor: Juei-Chao Chen, Taipei City (TW)

Correspondence Address: Juei-Chao, CHEN, P. O. BOX 46-563, Taipei, Taipei City, 10499, TW

(21) Appl. No.: 12/228,770

(22) Filed: Aug. 18, 2008

(51) Int. Cl. H05B 37/00; F21V 19/04

(52) U.S. Cl. 362/20; 362/425

(57) ABSTRACT

Disclosed is a multi-directional standby lighting device including a lamp seat and a plurality of lamps. Each of the lamps has a bottom provided with a universal joint for adjusting the lamp to an illumination angle suitable for the installation site, or toward a specific object. The lamp seat is provided therein with a plurality of connectors for connecting with the universal joints of the lamps, thereby allowing the lamps to be increased or decreased as needed in amount.

### BACKGROUND OF THE INVENTION

1. Technical Field

The present invention relates to a multi-directional standby lighting device, and more particularly, to a lighting device that allows adjustment of its illumination angle and the number of lamps installed therein.

2. Description of Related Art

As the Earth has been more and more densely populated, new buildings with increased heights have been constructed continuously. Therefore, people nowadays pay particular attention to fire accidents or other emergencies that may take place in the buildings. According to fire codes, all public places and each floor of a building must be equipped with proper indicating devices, emergency exit indicators or emergency lighting devices at exits or along escape routes, so that, with the assistance of these devices, people during a fire accident, earthquake, power outage or other emergencies can fully control on-site conditions and escape successfully via the escape routes, thereby reducing casualties. FIG. 1 shows an emergency lighting device 1 in wide use, which comprises a lamp seat 10 and two lamps 11 installed on the lamp seat 10. The emergency lighting device 1 is mostly provided at exits or along escape routes of public places and on each floor of a building. The emergency lighting device 1 is turned off in a standby mode and will be turned on as soon as power to the building is cut off during a fire accident, earthquake, power outage or other emergencies, whereupon the two lamps 11 on the lamp seat 10 cast light on indoor objects and specific locations, thereby allowing people to rapidly locate the escape routes or emergency exits in the dark. However, while the emergency lighting device 1 is capable of providing illumination, the light it casts comes only from the two lamps 11 and, as a result, the illumination effect is limited. Should one of the lamps 11 fail in an emergent situation, the intended illumination effect of the emergency lighting device 1 will be significantly reduced as there are no spare lamps to fill in. This has been a much-criticized drawback of the emergency lighting device 1.

Therefore, a solution to the aforesaid technical problem is attempted by the inventor of the present invention.

### BRIEF SUMMARY OF THE INVENTION

In view of the drawback of the prior art, the inventor of the present invention collected related information for comprehensive evaluation and consideration. After repeated trials and modifications, the inventor, based on years of experience in the industry, finally succeeded in developing a multi-directional standby lighting device that allows adjustment of its illumination angle and the number of lamps installed therein so as to provide enhanced illumination effect.

A primary objective of the present invention is to provide a standby lighting device comprising a plurality of lamps installed in an accommodating space of a lamp seat, wherein each of the lamps has a bottom provided with a universal joint that allows the lamp to be adjusted to a desired illumination angle or toward a specific object. Thus, when a fire accident or other emergencies take place, the lamps of the standby lighting device can cast light from different directions, thereby achieving enhanced illumination as well as good indicating and guiding effects.

A secondary objective of the present invention is to provide a plurality of connectors in the accommodating space of the lamp seat for connecting with the universal joints of the lamps, thereby allowing the lamps to be increased or decreased in amount as needed.

Another objective of the present invention is to provide a box-like lamp seat having an accommodating space for receiving the plurality of lamps, wherein the box-like lamp seat can be embedded in a ceiling, a wall or a floor of a building to reduce installation space and provide an esthetically improved appearance.

### BRIEF DESCRIPTION OF THE DRAWINGS

FIG. 1 is a perspective view of a conventional emergency lighting device;

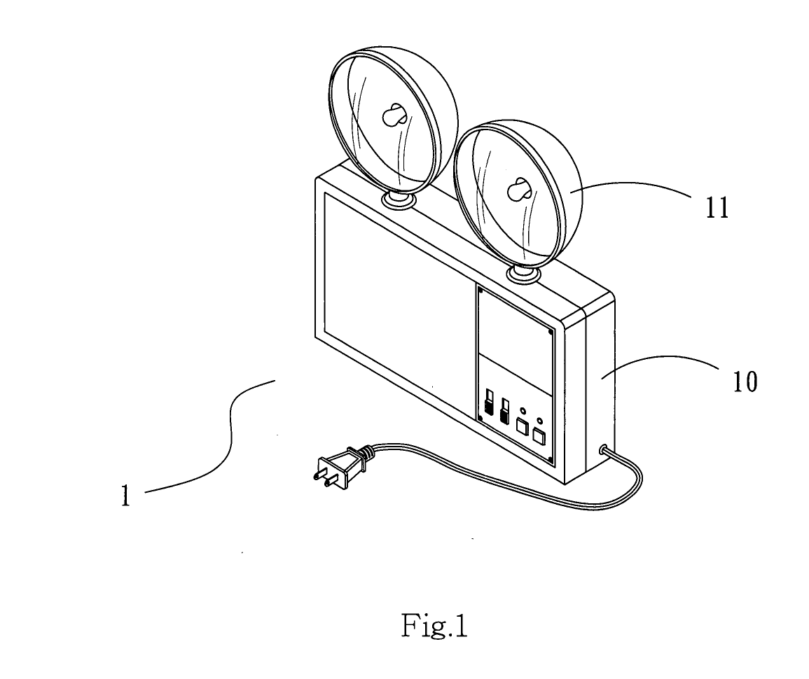

FIG. 2 is a perspective view of a multi-directional standby lighting device according to the present invention;

FIG. 3 is an exploded perspective view of the multi-directional standby lighting device according to the present invention;

FIG. 4 is a partial, enlarged view of the multi-directional standby lighting device according to the present invention;

FIG. 5 shows a first aspect of a first preferred embodiment the present invention;

FIG. 6 shows a second aspect of the first preferred embodiment the present invention;

FIG. 7 shows a third aspect of the first preferred embodiment the present invention;

FIG. 8 shows a fourth aspect of the first preferred embodiment the present invention;

FIG. 9 shows a fifth aspect of the first preferred embodiment the present invention;

FIG. 10 shows a sixth aspect of the first preferred embodiment the present invention;

FIG. 11 shows a seventh aspect of the first preferred embodiment the present invention;

FIG. 12 shows a first aspect of a second preferred embodiment the present invention;

FIG. 13 shows a second aspect of the second preferred embodiment the present invention; and

FIG. 14 shows a third aspect of the second preferred embodiment the present invention.

### DETAILED DESCRIPTION OF THE INVENTION

The structure and technical means adopted by the present invention to achieve the above objectives and effects can be best understood by referring to the following detailed description of features and functions of preferred embodiments in conjunction with the accompanying drawings.

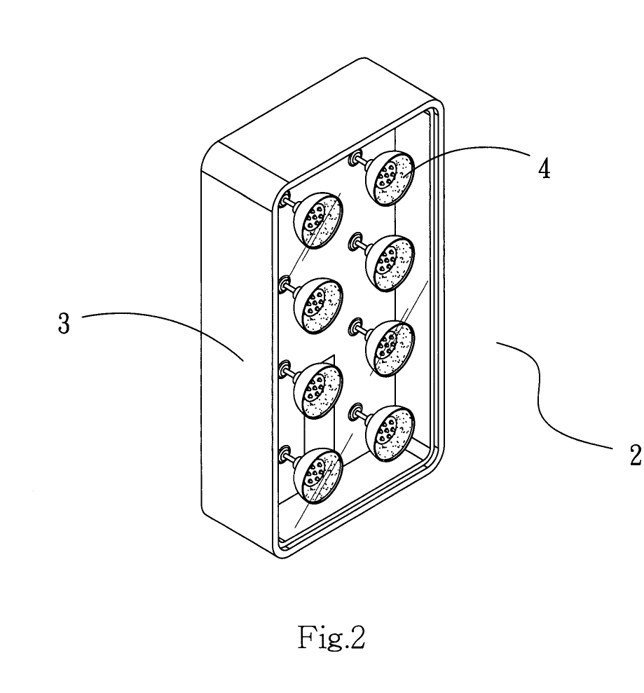

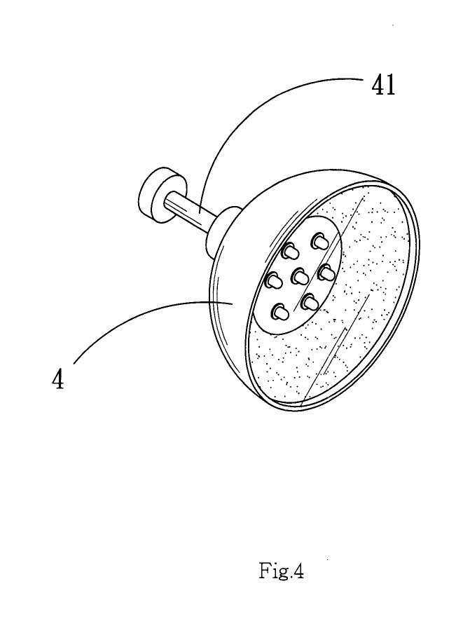

Please refer to FIGS. 2, 3 and 4 for a perspective view, an exploded perspective view and a partial, enlarged view of a standby lighting device 2 according to the present invention, respectively. As shown in the drawings, the standby lighting device 2 comprises a lamp seat 3, a plurality of lamps 4 and a transparent cover 5, wherein the lamps 4 can be light bulbs, light-emitting diodes (LEDs) or halogen lamps. An accommodating space 31 is formed in the lamp seat 3 and provided therein with a plurality of connectors 32, at least one power-supplying device 6 such as a rechargeable battery, and a switching device 7. Each of the lamps 4 has a bottom provided with a universal joint 41, whose distal end is connectable with a corresponding one of the connectors 32 in the accommodating space 31. The transparent cover 5 is disposed above the accommodating space 31 for covering and protecting the lamps 4 installed therein. According to the structure described above, the number of the lamps 4 can be increased or decreased as appropriate. In addition, the universal joints 41 at the bottoms of the lamps 4 allow the lamps 4 to be adjusted to desired illumination angles or toward specific objects.

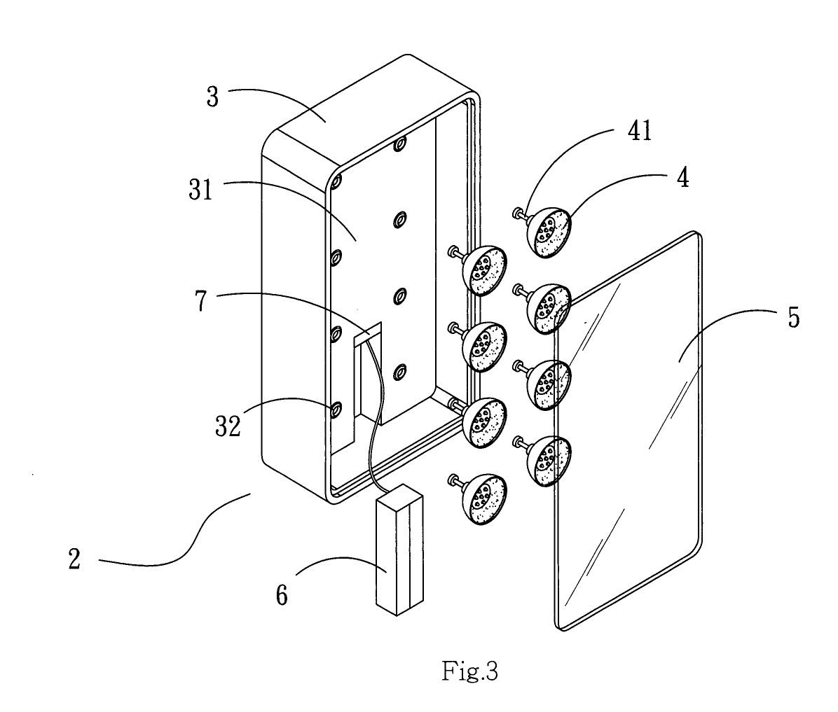

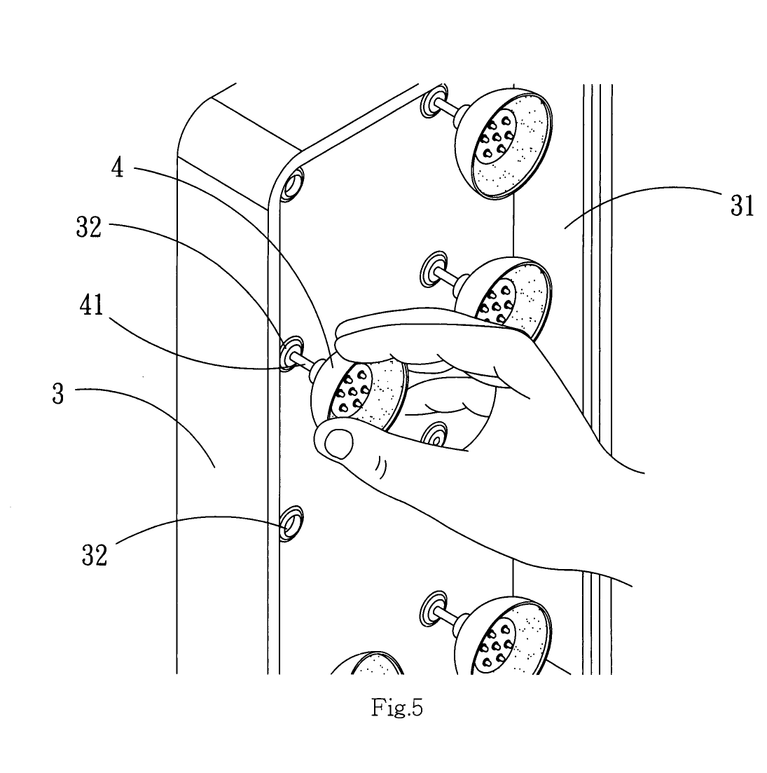

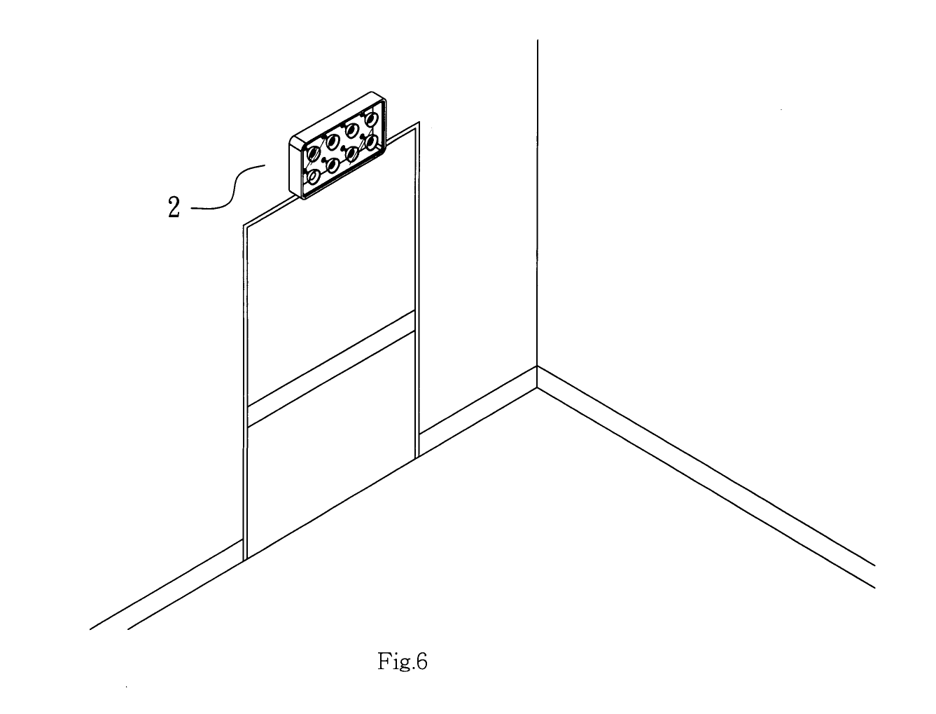

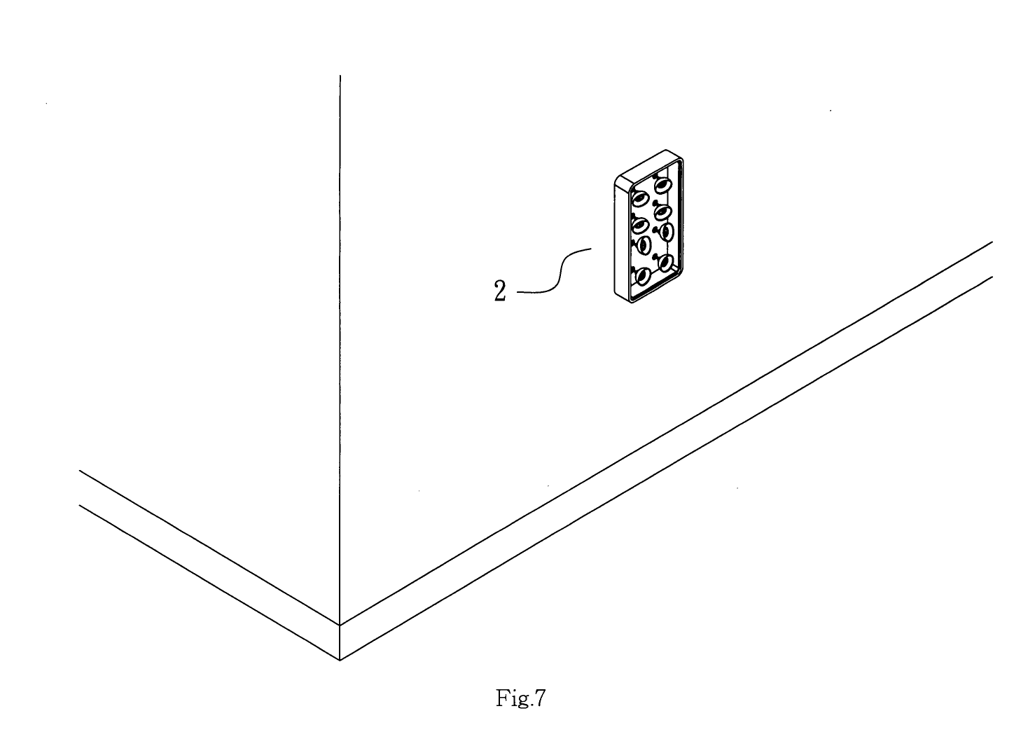

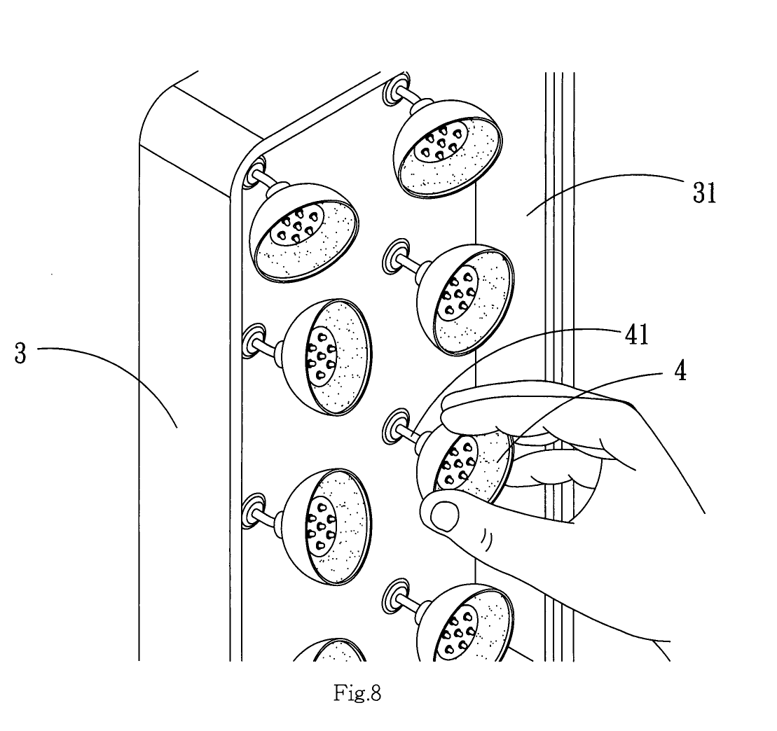

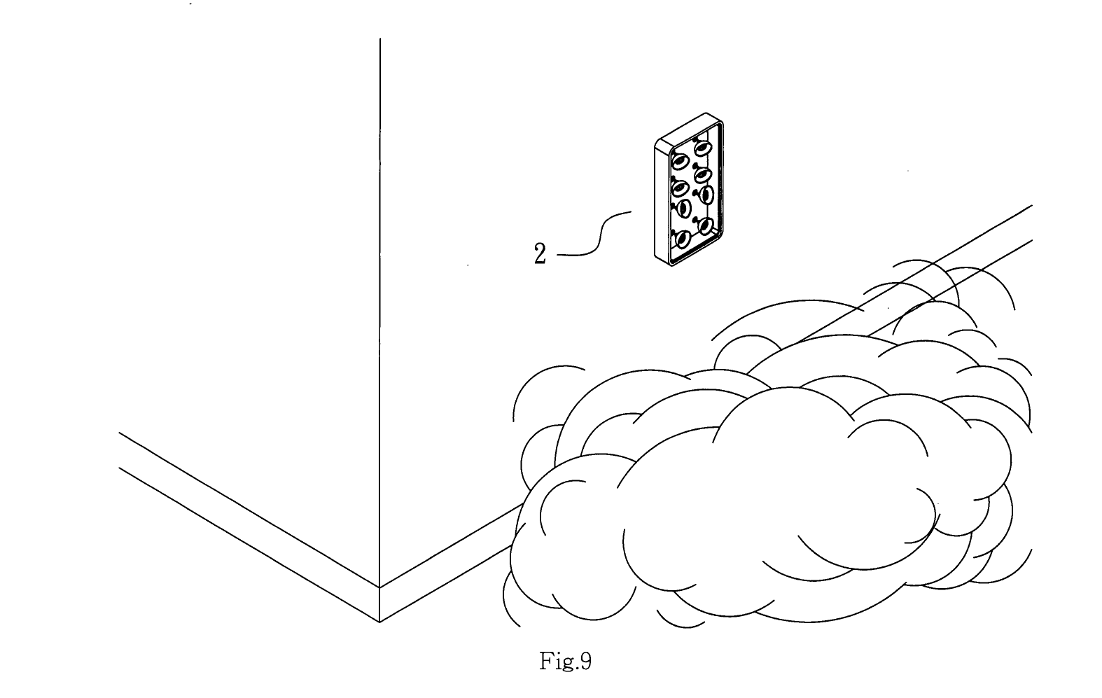

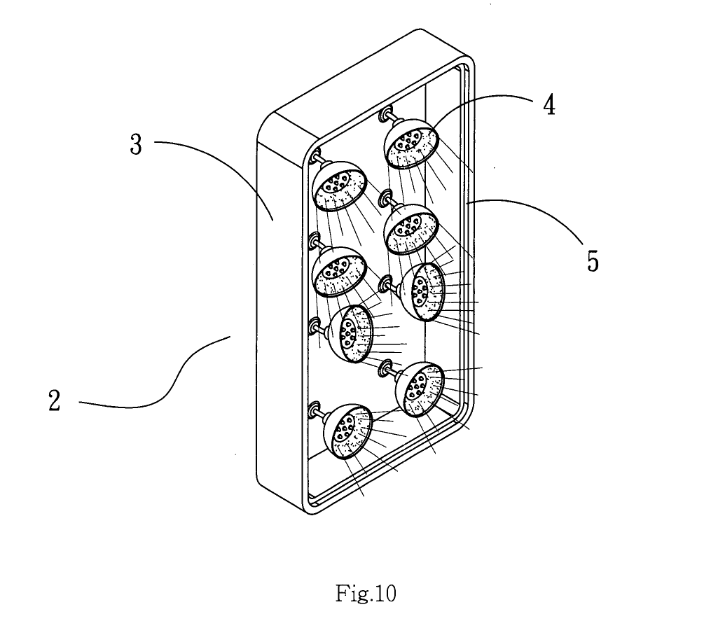

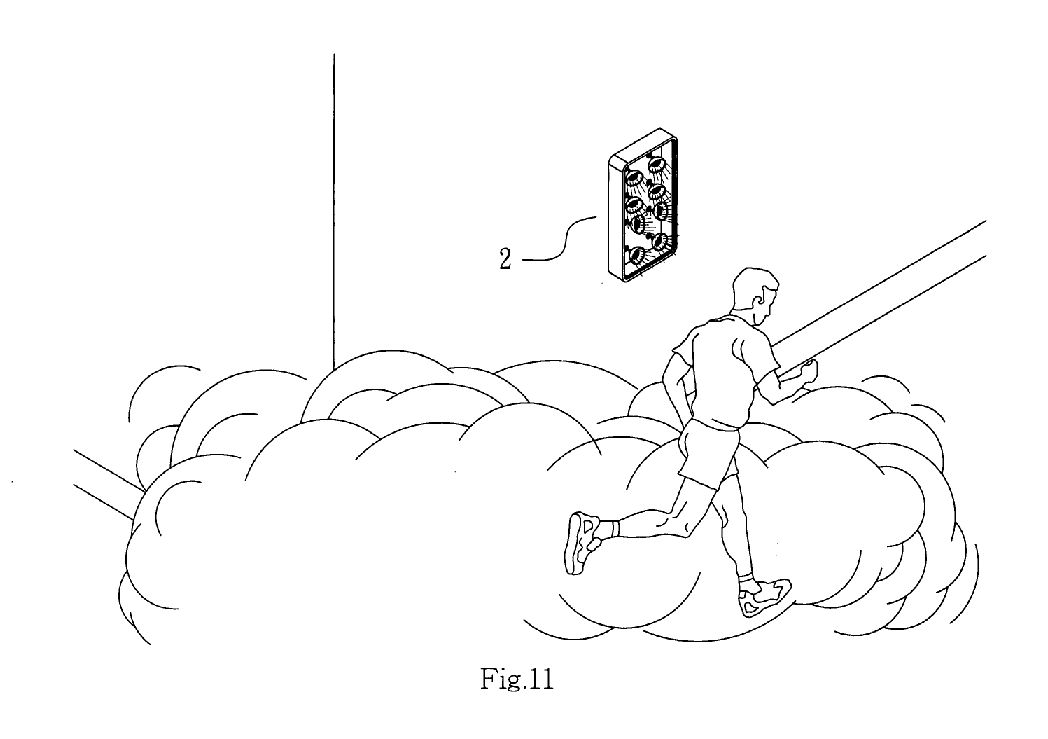

Please refer now to FIGS. 5 through 11 (in conjunction with FIG. 3) for a first preferred embodiment the present invention. As shown in the drawings, the standby lighting device 2 can be installed at an emergency exit or along an escape route. Besides, a desired number of the lamps 4 can be connected with the connectors 32 in the accommodating space 31 via the distal ends of the universal joints 41 at the bottoms of the lamps 4, while each of the lamps 4 can be adjusted to a desired illumination angle or toward a specific object via the universal joint 41 at the bottom of the lamp 4. When the adjustment is completed, the accommodating space 31 is covered with the transparent cover 5 to shield and protect the lamps 4 in the accommodating space 31. As soon as a fire accident, earthquake, power outage or other emergencies happen, the standby lighting device 2 is turned on so that the power-supplying device 6 is switched by the switching device 7 to supply electric power, thereby actuating the lamps 4 in the lamp seat 3 to illuminate an interior of a building or a specific location (such as an emergency door, an emergency exit or an escape route) and a specific object (such as a door knob, a cash register, switches on a stove, etc.). While heavy smoke or power outage caused by a fire accident hinders people from seeing clearly and locating the emergency exits and escape routes, the lamps 4 cast light from different directions to increase the illumination effect of the standby lighting device 2 and provide guiding and indicating functions. Since the lamp seat 3 of the standby lighting device 2 is installed therein with the plurality of lamps 4, the overall illumination effect will not be affected if only part of the lamps 4 are damaged.

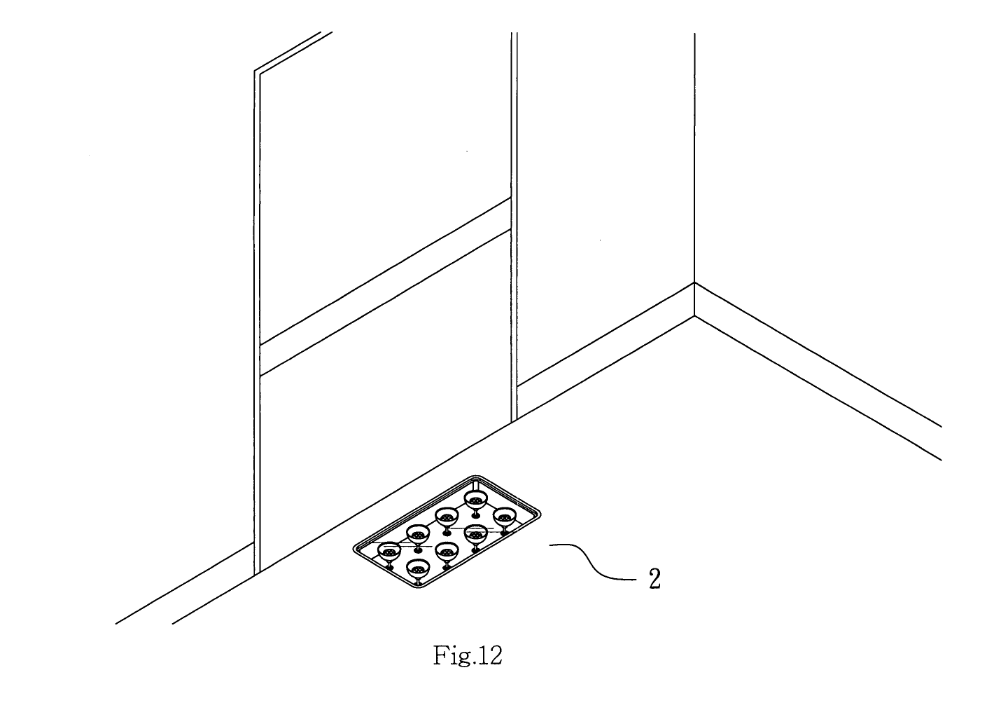

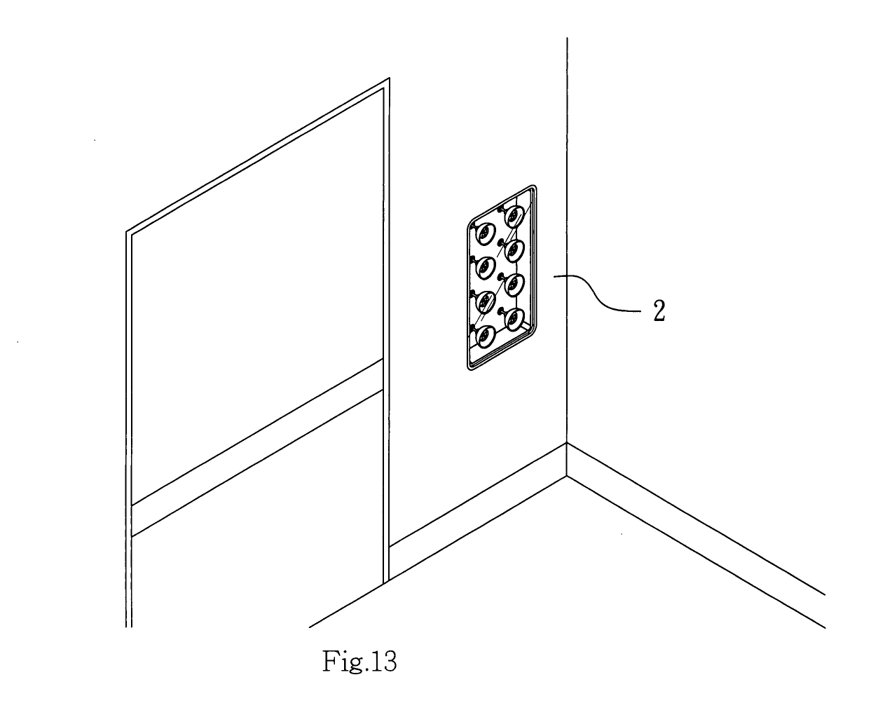

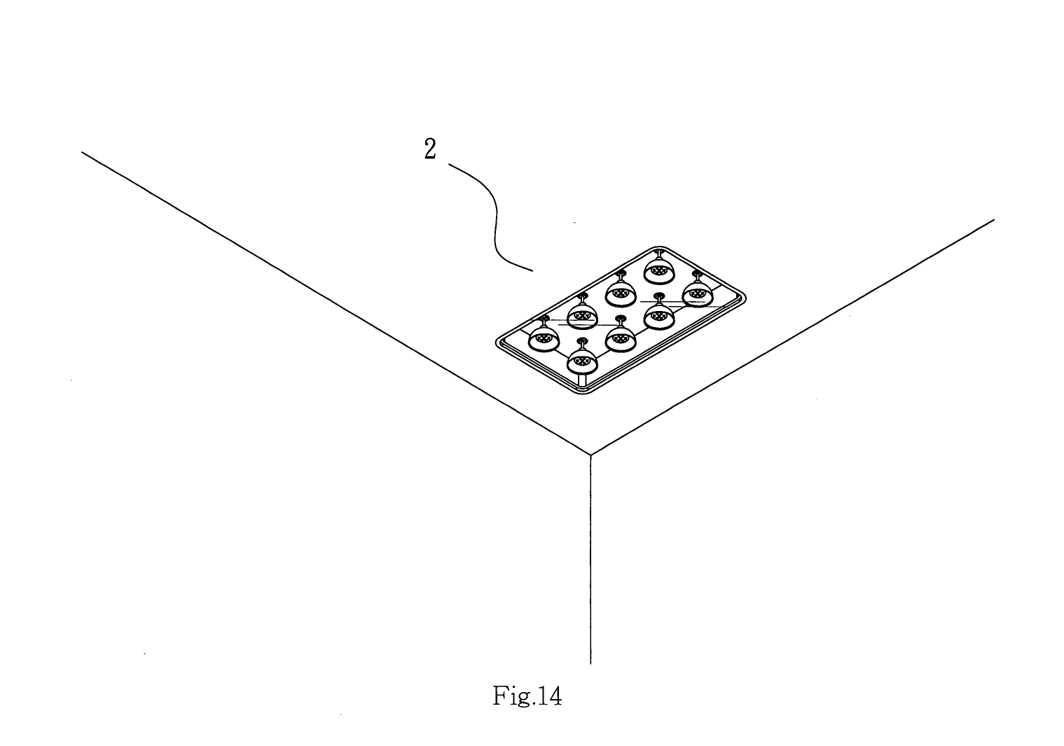

Please now refer to FIG. 12 through 14 (in conjunction with FIG. 3) for a second preferred embodiment of the present invention. As shown in the drawings, the lamp seat 3 of the standby lighting device 2 is shaped as a box, and all the lamps 4 are installed inside the lamp seat 3 and covered with the transparent cover 5. Hence, the standby lighting device 2 can be embedded in a ceiling, a wall or a floor of a building according to topographical conditions or requirement of space, thereby not only reducing installation space, but also providing an esthetically improved appearance that match an interior design of the building.

The present invention has been described with reference to preferred embodiments thereof and it is understood that the embodiments are not intended to limit the scope of the present invention.

1. A multi-directional standby lighting device, comprising:
a lamp seat is provided with a switching device having an accommodating space provided therein with a plurality of connectors; and
at least one lamp having a bottom connected with a universal joint;
wherein the universal joint at the bottom of each said lamp allows each said lamp to be adjusted to a desired illumination angle or toward a specific object, and the plurality of connecters in the accommodating space are connectable with the universal joints, thereby allowing the lamp to be increased or decreased in amount.

2. The multi-directional standby lighting device of claim 1, wherein the lamp is one of a light bulb, a light-emitting diode (LED) and a halogen lamp.

3. The multi-directional standby lighting device of claim 1, wherein the lamp seat is provided with a transparent cover for shielding and protecting the lamp.

4. The multi-directional standby fighting device of claim 1, wherein the lamp seat is provided therein with a power-supplying device.

5. The multi-directional standby lighting device of claim 4, wherein the power-supplying device is a rechargeable battery.

6. (canceled)
